(19) United States
(12) Patent Application Publication
(10) Pub. No.: US 2026/0244159 A1
(43) Pub. Date: Aug. 20, 2026

(54) INTEGRATED WATCH MOUNTING SYSTEM FOR DRYSUIT

(71) Applicant: SWITLIK PARACHUTE COMPANY, INC., Trenton, NJ (US)

(72) Inventors: Frank Stagliano, Metuchen, NJ (US); Stanley Switlik, Bay Head, NJ (US)

(73) Assignee: SWITLIK PARACHUTE COMPANY, INC., Trenton, NJ (US)

(21) Appl. No.: 19/534,041

(22) Filed: Feb. 9, 2026

Related U.S. Application Data
(60) Provisional application No. 63/760,339, filed on Feb. 19, 2025.

(51) Int. Cl. G04B 37/14; A41D 13/00; A41D 13/012

(52) U.S. Cl. CPC G04B 37/1433; A41D 13/0002; A41D 13/012; A41D 2600/10

(57) ABSTRACT

Systems and methods related to drysuits having an integrated watch-mounting portion are disclosed. A drysuit sleeve includes an arm-covering portion configured to enclose an arm of a wearer within an interior of the arm-covering portion. The drysuit sleeve further includes a seal portion extending from a distal end of the arm-covering portion, the seal portion configured to limit water incursion into the interior of the arm-covering portion. The drysuit sleeve further includes a cuff portion extending from the arm-covering portion exterior to the seal portion, the cuff portion including a watch-mounting portion having a slot configured to receive a watch strap. The watch-mounting portion is configured to receive an outward-facing watch.

### CROSS REFERENCE TO RELATED APPLICATIONS

This application claims the priority benefit of U.S. Provisional Patent Application No. 63/760,339, filed Feb. 19, 2025, the disclosure of which is hereby incorporated herein by reference in its entirety.

### BACKGROUND

A drysuit is a garment worn to protect the user from adverse environmental conditions. Two common purposes are to insulate the wearer against excessive heat loss, and to isolate the wearer from direct contact with a liquid environment during immersion or repeated multi-directional contact with liquids which may include hazardous chemicals or biological contaminants. Insulation is typically provided by garments worn under the drysuit, which the drysuit functions to keep dry. Drysuits are often used by divers, boaters, and people who work or play in or near cold or contaminated water. Components include a waterproof shell, seals, and a watertight entry closure.

Rescue swimmers and search and rescue personnel, often involved in high-risk and time-sensitive operations in challenging aquatic environments, may benefit from real-time tracking of their location and situational awareness. Current methods of tracking, such as handheld GPS devices, are cumbersome and hinder the swimmer's performance due to the risk of losing the device or the difficulty of accessing it quickly during rescue operations. GPS watches, when worn over the wrist seal of a dry suit, create an unwanted air pocket or “bubble” that interferes with the suit's fit and functionality. The trapped air prevents the wrist seal from forming a secure, waterproof bond, which reduces the suit's effectiveness and can cause discomfort for the swimmer. Furthermore, the presence of the air pocket can limit the swimmer's mobility, impede the GPS device's performance, and present operational safety risks.

This document describes methods and systems that address issues such as those discussed above, and/or other issues.

### SUMMARY

The present disclosure describes embodiments related to drysuits having an integrated watch-mounting portion. In one aspect, a drysuit sleeve includes an arm-covering portion configured to enclose an arm of a wearer within an interior of the arm-covering portion. The drysuit sleeve further includes a seal portion extending from a distal end of the arm-covering portion, the seal portion configured to limit water incursion into the interior of the arm-covering portion. The drysuit sleeve further includes a cuff portion extending from the arm-covering portion exterior to the seal portion, the cuff portion including a watch-mounting portion having a slot configured to receive a watch strap. The watch-mounting portion is configured to receive an outward-facing watch.

Implementations of the disclosure may include one or more of the following optional features. In some examples, the slot includes slits formed in the cuff portion. The drysuit sleeve may further include a watch-covering portion including a flap configured to cover a watch mounted in the watch-mounting portion. The watch-covering portion may further include a window portion configured to provide visibility to the watch. The watch-covering portion may further include an attachment element configured to provide a resealable bond with the cuff portion.

In another aspect, a drysuit includes a drysuit sleeve including a watch-mounting portion having a slot configured to receive a watch strap and configured to receive an outward-facing watch.

In another aspect, a method of donning a watch includes donning a drysuit including a watch-mounting portion having a slot configured to receive a watch strap and configured to receive an outward-facing watch. The method further includes mounting a watch in the watch-mounting portion. The steps of this method may be performed in any order.

Implementations of the disclosure may include one or more of the following optional features. In some examples, mounting a watch in the watch-mounting portion includes threading a strap through the slot in the cuff portion and attaching the strap to lugs of the watch. The method may further include covering the watch with a watch-covering portion of the drysuit sleeve. The method may further include resealably bonding the watch-covering portion to the drysuit sleeve using an attachment element of the watch-covering portion.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 shows an example drysuit sleeve.

FIG. 2 shows a closeup view of a portion of the example sleeve.

FIG. 3 shows an example watch.

FIG. 4 shows an example cover flap.

FIG. 5 shows an example flowchart.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun or phrase, such use is simply intended to distinguish one item from another and is not intended to require a sequential order unless specifically stated. The term “about” when used in connection with a numeric value, is intended to include values that are close to, but not exactly, the number. For example, in some embodiments, the term “about” may include values that are within +/−10 percent of the value.

The present disclosure relates generally to methods and systems related to attaching a watch, such as a GPS watch to the exterior of a cuff portion of a drysuit sleeve. In some examples, the watch is securely attached to the cuff of the suit without the need for the watch band to wrap around the suit. By eliminating the watch band that wraps around the circumference of the suit cuff/wrist, air is not trapped in the sleeve of the suit, rectifying any impairment of swimming ability and risk of trapping excess buoyancy in the suit or preventing the wrist seal from forming a secure, waterproof seal. When the watch is securely attached to the cuff of the suit, the wearer is able to easily view the face of the watch and (in the case of GPS watches), track their location in real-time.

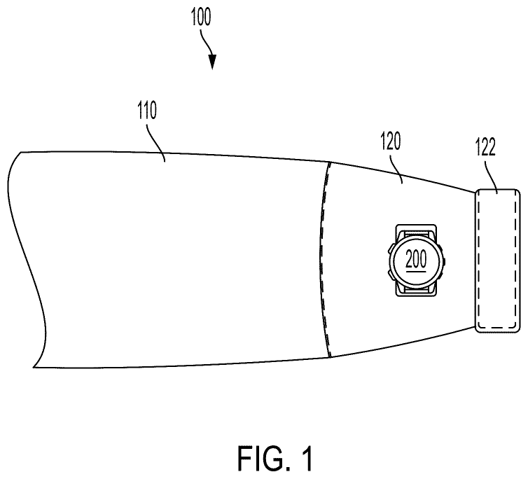

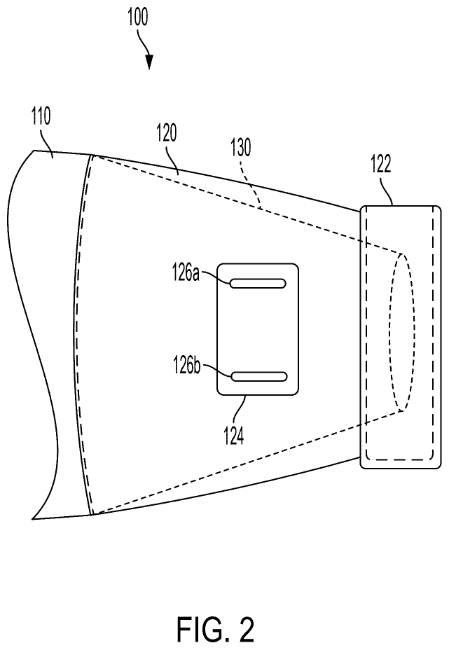

FIG. 1 shows an example drysuit sleeve 100 onto which a watch 200 has been mounted. As shown, a GPS-enabled watch is mounted in a watch-mounting portion (124, FIG. 2) and in an outward-facing orientation such that the wearer can readily see its face. That is, the watch-mounting portion 124 may be configured such that the watch 200 is outward-facing. In some examples, the drysuit is a one-piece garment, that may include feet coverings, leg coverings, a torso covering, and sleeves 100 for covering the wearer's arms. The drysuit may include one or more seals, e.g., at the wearer's neck, wrists, and/or ankles, and may otherwise be configured to limit water incursion into the interior portions of the drysuit, including interior portions of the sleeves 100 and other components of the drysuit. The sleeve 100 may extend away from the torso-covering portion of a drysuit and enclose an arm of the wearer. In some examples, the distal end of the arm-covering portion 110 of sleeve 100 interfaces with a seal portion (130, FIG. 2) comprising a wrist seal which limits water incursion into the interior of the sleeve. As shown, the sleeve 100 also includes a cuff portion 120 that extends over the seal portion 130 and which may be tightly secured around the wrist of the wearer with a Velcro strap 122 or other cinching system.

Referring to FIG. 2, a close-up of the cuff portion 120 is shown, with the seal portion 130 shown in dashed lines. The wrist seal portion 130 may be made of rubber, silicon, neoprene, and/or other materials that conform to the wearer's anatomy closely enough to effect a seal against water incursion. In other examples, the seal portion includes a hand covering, such as a glove, which serves to seal the sleeve 100 against water incursion. Because the cuff portion 120 is exterior to the seal portion 130, the cuff portion 120 may provide protection to the seal portion 130 against damage. Furthermore, because the seal portion 130 limits water incursion into the sleeve 100 (and, thus, into the drysuit), the cuff portion 120 does not need to limit water incursion into the drysuit. Therefore, the cuff portion 120 may have different characteristics than the seal portion 130. For example, the cuff portion 120 may be constructed from different materials than the seal portion 130. These materials may include fabric coated with vulcanized rubber, laminated layers of nylon and butyl rubber (e.g., trilaminate), Cordura proofed with an inner layer of polyurethane, or other sturdy, protective materials and/or combinations of materials. In some examples, the cuff portion 120 does not fully surround and enclose the seal portion 130. However, even partially covering the seal portion 130 may provide sufficient protection against damage.

The cuff portion 120 may also include a watch-mounting portion 124. Referring back to FIG. 2, the watch-mounting portion 124 may include a slot (e.g., comprising slits 126a-b) configured to receive a belt, strap, webbing, or other fastening element may be threaded to secure the watch 200. As described in more detail below, the strap may be secured to the watch by a knot, snap, magnet, buckle, Velcro, or the like. As described above, it is the seal portion 130, not the cuff portion 120, that limits water incursion into the drysuit. Therefore, slits (e.g., 126a-b) may be formed in cuff portion 120 without compromising the integrity of drysuit's seal against water incursion. The area surrounding the slits 126 may be reinforced, e.g., with an extra layer of material, to add to durability of the watch-mounting portion 124.

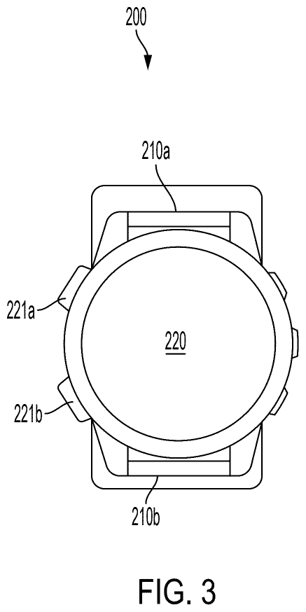

FIG. 3 shows an example watch 200 that may be mounted at the watch-mounting portion 124. In some examples, the watch is a GPS-enabled watch. As shown, the watch includes strap lugs 210a-b, e.g., elongated elements on either side of the watch face where a strap or bracelet is normally attached. Such a watch 200 may be mounted to the watch-mounting portion 124 by threading/inserting/routing a strap (or equivalent) through slits 126 of the watch-mounting portion 124 and securing the strap to corresponding lugs 210a-b on each side of the watch face 220. The strap(s) may be secured using a hook-and-loop fastener, such as Velco, or by a clasp, buckle, or the like. The watch 200 may have one or more control buttons (e.g., 221a, 221b). As shown, the control buttons 221 are disposed on the sides of the watch 200. In this configuration, access to the control buttons 221 is not compromised by attaching the watch as described above. That is, attaching a strap to lugs 210 that are located at opposite sides of the watch face 220, leaves the sides of the watch 200 relatively unobstructed. Therefore, even a wearer with gloved hands may be able to effectively operate the control buttons 221 of the watch 200.

In some examples, the watch-mounting portion 124 includes a mounting system which allows the watch 200 to be easily mounted to and unmounted from the watch-mounting portion 124, e.g., without requiring specialized tools. The mounting system may include a bayonet mount or similar mechanism for a compatible watch 200 to mate with. In one example, the back of the watch 200 includes tabs, pegs, or similar protrusions which may be inserted into matching slots in the mounting system, after which, the watch 200 may be rotated (e.g., ninety degrees) to lock the watch 200 in place. The mounting system may include biasing members, detents, or other features to help retain the watch 200 in the locked position, but which can be overcome by using a sufficient twisting force.

In other examples, the mounting system may include hooks configured to connect with matching lugs 210a-b on each side of the watch face 220. The hooks, in turn, may be attached to the watch-mounting portion 124 by, e.g., elastic straps to apply a force to the hooks in a direction away from the watch face 220, to help the hooks securely retain the watch 200, but which allow the wearer to remove the watch 200 by applying sufficient force to overcome the force from the straps, without requiring specialized tools. In some examples, the hooks are configured to be substantially the same width as the matching lugs 210a-b, so as to resist any tendency of the watch 200 to twist during use. In some examples, the hooks include latches, gates, or other mechanism to more securely connect with the matching lugs 210a-b. In some examples, the latches, gates, or other mechanism includes a biasing element configured to retain the matching lugs 210a-b within the hooks.

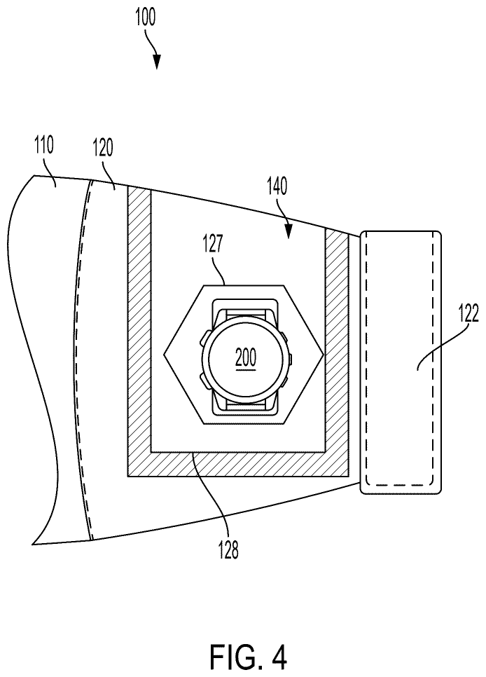

FIG. 4 shows an example cuff portion 120 that includes a watch-covering portion 140 that may offer additional security and protection to the watch 200. As shown, watch-covering portion 140 is a flap that extends over the watch 200 and is held in place by an attachment element 128. Cover flap 140 includes a window 127, through which the watch face 220 may be seen. Thus, visibility of the watch face 220 may be maintained even when the watch 200 is covered by flap 140. As shown, window 127 is hexagonal, however, window 127 may also be in the form of a different shape, including (but not limited to) a circle or a square. In other examples, cover flap 140 does not include window 127. That is, cover flap 140 may completely cover watch 200, such that cover flap 140 must be opened to see the watch face 220. Regardless of whether cover flap 140 includes window 127, attachment element 128 may form a resealable bond with the cuff portion 120. For example, the attachment element 128 may include Velcro, snaps, magnets, zippers, or the like, allowing the cover flap 140 to be opened and closed as needed by the wearer. In other examples, the cover flap 140 is permanently sealed in a closed configuration. Like the cuff portion 120, the watch-covering portion 140 may include sturdy materials to provide additional protection to watch 200. In examples that include window 127, window 127 may include a polymer sheet or film.

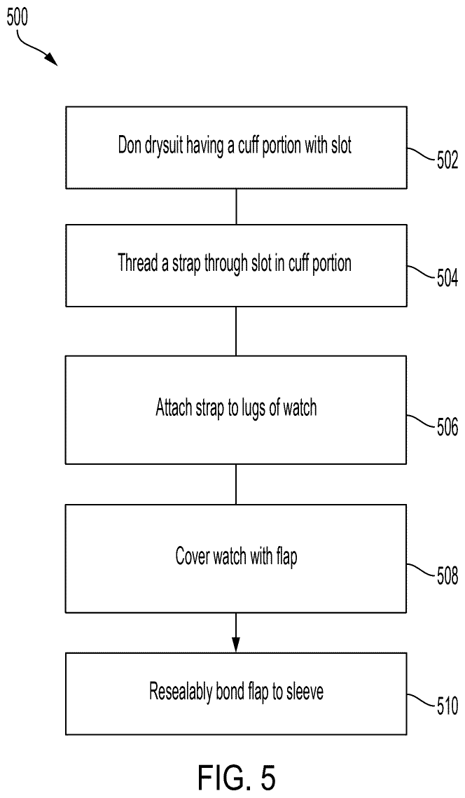

FIG. 5 shows an example flowchart 500 for a method of donning a watch 200. The steps of the method may be performed in any order. At step 502, the method includes donning a drysuit having a drysuit sleeve and a cuff portion extending from the arm-covering portion of the drysuit sleeve, the cuff portion including a slot configured to receive a watch strap. In some examples, the slot is part of a watch-mounting portion configured to receive an outward-facing watch. The slot may include multiple slits in the cuff portion through which the watch strap may be threaded.

At step 504, the method includes mounting a watch in the watch-mounting portion, e.g., by threading a strap through the slot in the cuff portion. As described above, steps associated with mounting the watch in the watch-mounting portion may be performed either before or after steps associated with donning the drysuit. At step 506, the method includes attaching the strap to lugs of the watch. At step 508, the method includes covering the watch with a watch-covering portion of the drysuit sleeve. At step 510, the method includes resealably bonding the watch-covering portion to the drysuit sleeve using an attachment element of the watch-covering portion. For example, the attachment element may include a hook-and-loop fastening system, and resealably bonding the watch-covering portion to the drysuit sleeve may include applying the hook-and-loop fastening system of the watch-covering portion to a mating element of the cuff portion. Other fastening systems may also be used, including (but not limited to) snaps, zippers, and so forth.

While the invention has been described with specific embodiments, other alternatives, modifications and variations will be apparent to those skilled in the art. Accordingly, it will be intended to include all such alternatives, modifications, and variations within the spirit and scope of the appended claims.

1. A drysuit sleeve comprising:
an arm-covering portion configured to enclose an arm of a wearer within an interior of the arm-covering portion;
a seal portion extending from a distal end of the arm-covering portion, the seal portion configured to limit water incursion into the interior of the arm-covering portion; and
a cuff portion extending from the arm-covering portion exterior to the seal portion, the cuff portion comprising a watch-mounting portion comprising a slot configured to receive a watch strap, the watch-mounting portion configured to receive an outward-facing watch.

2. The drysuit sleeve of claim 1, wherein the slot comprises slits formed in the cuff portion.

3. The drysuit sleeve of claim 1, further comprising a watch-covering portion comprising a flap configured to cover a watch mounted in the watch-mounting portion.

4. The drysuit sleeve of claim 3, wherein the watch-covering portion further comprises a window portion configured to provide visibility to the watch.

5. The drysuit sleeve of claim 3, wherein the watch-covering portion further comprises an attachment element configured to provide a resealable bond with the cuff portion.

6. A drysuit comprising the drysuit sleeve of claim 1.

7. A method of donning a watch, the method comprising:
donning a drysuit comprising the drysuit sleeve of claim 1; and
mounting a watch in the watch-mounting portion.

8. The method of claim 7, wherein mounting a watch in the watch-mounting portion comprises:
threading a strap through the slot in the cuff portion and attaching the strap to lugs of the watch.

9. The method of claim 7, further comprising covering the watch with a watch-covering portion of the drysuit sleeve.

10. The method of claim 9, further comprising resealably bonding the watch-covering portion to the drysuit sleeve using an attachment element of the watch-covering portion.
